(19) United States
(12) Patent Application Publication
(10) Pub. No.: US 2013/0048659 A1
(43) Pub. Date: Feb. 28, 2013

(54) Placemat for a container

(71) Applicant: Diane Marie DeDominicis, Wappingers Falls, NY (US)

(72) Inventor: Diane Marie DeDominicis, Wappingers Falls, NY (US)

(21) Appl. No.: 13/199,292

(22) Filed: Aug. 25, 2011

(51) Int. Cl. B65D 43/16; B32B 3/10; A47G 23/00; B32B 3/02

(52) U.S. Cl. 220/810; 428/64.1; 428/80; 428/195.1; 428/67; 428/99; 428/100; 428/221; 428/457; 428/500

(57) ABSTRACT

The present invention relates generally to a placemat. More particularly, the invention encompasses a placemat for a container. The present invention is also directed to a novel placemat that can be placed inside a lunch box or a similar container. The present invention is also directed to a novel placemat that can be removably secured to the inside surface of a lid or an inside surface of a container. The novel placemat could also have either discrete magnets or at least one magnetic layer secured thereto. The present invention is also directed to a combination placemat and lunch box.

### FIELD OF THE INVENTION

The present invention relates generally to a placemat. More particularly, the invention encompasses a placemat for a container. The present invention is also directed to a novel placemat that can be placed inside a lunch box or a similar container. The present invention is also directed to a novel placemat that can be removably secured to the inside surface of a lid or an inside surface of a container. The novel placemat could also have either discrete magnets or at least one magnetic layer secured thereto. The present invention is also directed to a combination placemat and lunch box.

### BACKGROUND INFORMATION

Placemats of various shapes and sizes have been known and used for many years to protect the surface of tabletops and the like against damage when a tablecloth or other protector is not used. Such placemats tend to be less expensive than tablecloths, easier to store, and easier to clean.

Placemats have also been used in an attempt to protect children from unclean surfaces and reduce clean-up time. Such placemats are usually substantially planar mats formed of either disposable paper or reusable plastic. These types of devices reduce the workload associated with cleaning them between meals.

Bags for carrying food items, such as, lunchboxes or paper bags, are popular with children who bring their lunches and/or snacks to school. Usually the children will sit at a table in a cafeteria and take their lunch out to eat at the designated time. The tables at which they sit often present unsanitary conditions since other children may have just left the table after eating their lunch, and the table may not have been cleaned or disinfected. Parents may place into the lunchbox paper towels, napkins or other devices on which the lunch should be placed for eating, but many times the children may forget to lay out the napkin or opt not to use it for fear of reprisal by classmates.

Efforts to improve the basic design of a placemat have had limited success.

U.S. Patent Publication No. 2004/0175539 (Andrew Shevins), the entire disclosure of which is incorporated herein by reference, discloses a placemat that has two sides sewn together along the periphery by spaced stitch lines. One side is cut from a sheet of fabric. The other side is cut from a sheet of vinyl. The edge portions of the sheets are folded and situated between the sides prior to stitching.

U.S. Patent Publication No. 2007/0051864 (Lindy Lee Bartell, et al.), the entire disclosure of which is incorporated herein by reference, discloses a cost effective, durable, safe, and washable placemat that remains in place during use, contain spills that arise during meal time, and collects food and other debris before it falls on the floor is disclosed. In one disclosed embodiment, the reusable placemat has a substantially planar eating surface that is encircled by a spill retention rim with a food retention gutter detachably secured thereto. A resilient strip of material preferably encircles the lower side of the placemat thereby defining a non-slip foot. The planar eating surface may be substantially transparent, thereby allowing one or more activity cards to be displayed therethrough.

U.S. Patent Publication No. 2009/0120978 (Rebecca Lesser), the entire disclosure of which is incorporated herein by reference, discloses a bag for carrying items such as food items, the bag having an attached foldable mat that may be selectively opened or closed by the user. When in the open position the mat provides a surface usable by the user for eating or the like. When in the closed position the mat is secured against the enclosure and out of the way of the user.

U.S. Patent Publication No. 2010/0092108 (Crystal Figlietti), the entire disclosure of which is incorporated herein by reference, discloses a reusable, easily washable, eco-friendly food container that contains an enclosed pouch and a placemat. The eco-friendly food container folds over itself for spill free storage and in its open position is capable of wrapping around a horizontal bar to hang open so the pouch contents are easily accessible. A removable pouch tray facilitates food handling inside and outside of the pouch.

U.S. Patent Publication No. 2010/0133141 (Caroline Lebel, et al.), the entire disclosure of which is incorporated herein by reference, discloses a lunch box transforming into a placemat has at least two zippers with one of the two zippers running along at least three but preferably four sides while the second zipper runs along the remaining sides so as to allow, when all unzipped, to open the lunch box so that it lays flat and becomes a placemat.

This invention improves on the deficiencies of the prior art and provides an inventive placemat along with an inventive container.

### PURPOSES AND SUMMARY OF THE INVENTION

The invention is a novel placemat for a container.

Therefore, one purpose of this invention is to provide a cost effective, durable, safe, and washable placemat.

Another purpose of this invention is to provide a reusable placemat that has a substantially planar surface when in use.

Yet another purpose of this invention is to provide a placemat that can be secured to the inside surface of a lid or a container.

Therefore, in one aspect this invention comprises a washable placemat, comprising:

(a) a first layer, a second layer secured to said first layer; and

(b) wherein said first layer and said second layer are made from a recycled, recyclable material, and thereby forming said washable placement.

In another aspect this invention comprises a lunch box, comprising:

(a) a container formed by four walls with a base secured to the bottom edges of said four walls;

(b) a cover hingeably secured to an upper edge of a wall; and

(c) said lunch box having at least one means to internally securely hold at least one placemat.

In yet another aspect this invention comprises a combination placemat and lunch box, comprising:

(a) a container formed by four walls with a base secured to the bottom edges of said four walls;

(b) a cover hingeably secured to an upper edge of a wall, and forming said lunch box;

(c) said lunch box further having at least one first means to internally, removably, and securely hold at least one placemat; and

(d) a placemat having at least one second means to be removably, and securely, be held by said at least one first means in said lunch box that internally, removably, and securely holds said at least one placemat.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1A illustrates a top view of a first embodiment of the placemat invention.

FIG. 1B illustrates a top view of a second embodiment of the placemat invention.

FIG. 1C illustrates a top view of a third embodiment of the placemat invention.

FIG. 1D illustrates a top view of a fourth embodiment of the placemat invention.

FIG. 1E illustrates a top view of a fifth embodiment of the placemat invention.

FIG. 1F illustrates a top view of a sixth embodiment of the placemat invention.

FIG. 2A illustrates a detailed cut-away side view of a seventh embodiment of the placemat invention.

FIG. 2B illustrates a detailed cut-away side view of an eighth embodiment of the placemat invention.

FIG. 2C illustrates a detailed cut-away side view of a ninth embodiment of the placemat invention.

FIG. 3 illustrates a detailed perspective view showing a tenth embodiment of the placemat invention, along with an inventive lunch box.

### DETAILED DESCRIPTION

The “Lunch Pad” or “Lunch Spot” is preferably a pad or a placemat made from material, such as, recycled material. It is preferable that the pad or placemat is washable and flexible in nature. The “Lunch Pad” could be, for example, approximately 12 inches in diameter and would be able to roll or fold up to fit inside a lunch box. One of the main purposes of this invention is to provide a sanitary space while consuming food items, such as, in a cafeteria setting.

It is contemplated that the “Lunch Pad” primary market would be for mothers with school age children.

It should be understood that the “Lunch Spot” could be manufactured in different colors, and/or various shapes, and/or with various interesting graphics or verbiage.

It should be appreciated that the graphics and verbiage could be seasonal related, and/or targeted to different age groups, and/or also could include popular characters within the different age groups or community.

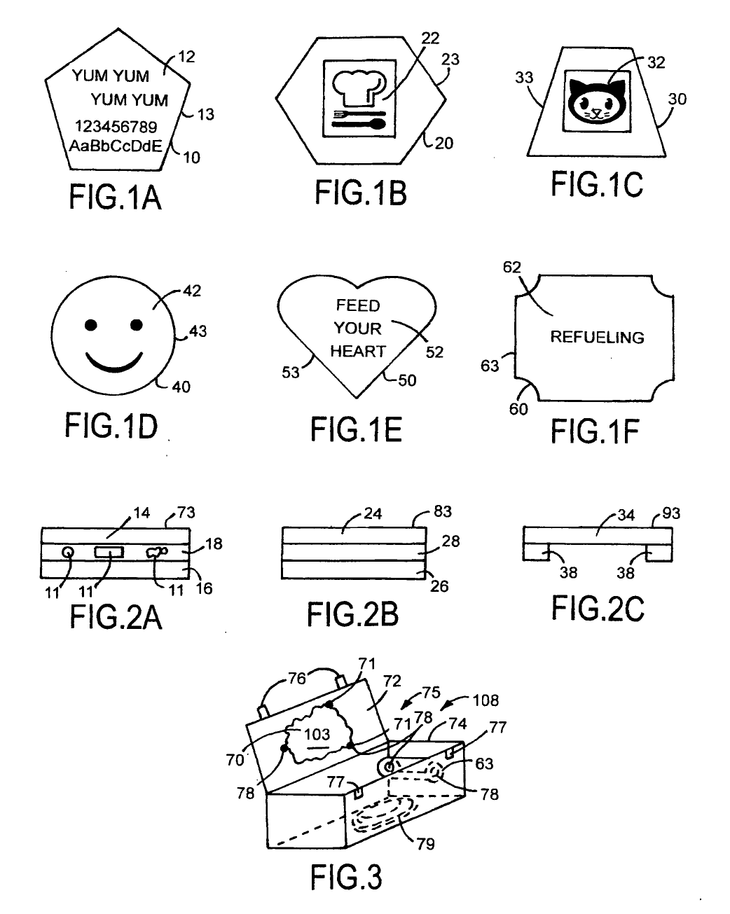

FIG. 1A illustrates a top view of a first embodiment of the placemat 13 invention. The placemat 13, comprises of a polygonal shaped placemat 10, such as, a pentagonal shaped placemat 10, having a rhyme or alphabets or numeral or symbols or indicia 12, on the face or surface of the placemat 13.

FIG. 1B illustrates a top view of a second embodiment of the placemat 23 invention. The placemat 23, comprises of a polygonal shaped placemat 20, such as, an octagonal shaped placemat 20, having a picture or illustration 22, on the face or surface of the placemat 23.

FIG. 1C illustrates a top view of a third embodiment of the placemat 33 invention. The placemat 33, comprises of a rectangular shaped placemat 30, such as, a trapezoid shaped placemat 30, having a photograph or a scenery 32, on the face or surface of the placemat 33.

FIG. 1D illustrates a top view of a fourth embodiment of the placemat 43 invention. The placemat 43, comprises of a circular or elliptical shaped placemat 40, having a gesture 42, such as, a smiley face 42, on the face or surface of the placemat 43.

FIG. 1E illustrates a top view of a fifth embodiment of the placemat 53 invention. The placemat 53, comprises of a heart shaped placemat 50, having a statement or phrase 52, on the face or surface of the placemat 53.

FIG. 1F illustrates a top view of a sixth embodiment of the placemat 63 invention. The placemat 63, comprises of an ornamental shaped placemat 60, having a word 62, on the face or surface of the placemat 63.

FIG. 2A illustrates a detailed cut-away side view of a seventh embodiment of the placemat 73 invention. The placemat 73, comprises a first or upper layer 14, a second or lower layer 16, and a third or middle layer 18. The third layer 18, comprises at least one discrete magnet 11, and the third layer 18, is sandwiched by the first layer 14, and the second layer 16.

FIG. 2B illustrates a detailed cut-away side view of an eighth embodiment of the placemat 83 invention. The placemat 83, comprises a first or upper layer 24, a second or lower layer 26, and a third or middle layer 28. The third layer 28, comprises at least one magnetic layer 28, and the third layer 28, is sandwiched by the first layer 24, and the second layer 26.

FIG. 2C illustrates a detailed cut-away side view of a ninth embodiment of the placemat 93 invention. The placemat 93, comprises a first or upper layer 34, and secured to the first layer 34, is at least one securing means 38. The at least one securing means 38, is selected from a group comprising, a magnet, a snap, a hook and loop item, a button, to name a few.

FIG. 3 illustrates a detailed perspective view showing a tenth embodiment which is a combination placemat and container 108, comprising a placement 103, which is securely, removably secured to an inventive lunch box 75, or a similar container 75. The placemat 103, comprises of an odd shape or an irregular shaped placemat 70, having at least one securing means 78. The inventive lunch box 75, comprises of a container 74, having a lid or cover 72. It is preferred that the surface of the lid 72, that faces the container 74, has secured thereto at least one securing means 71, such that the securing means 71, mates with securing means 78, and secures the placemat 103, to the lid 72. One or more of the inner walls of the container 74, could also have securing means 71 (not shown) to secure a placemat, such as placemat 63, and/or placemat 103. The container 74, also has enough space for contents 79, such as, sandwich 79, utensils 79, paper products 79, food items 79, to name a few. Optionally, the lunch box 75, could also have securing means 76, 77, to secure the lid 72, to the container 74. Securing means 76, 77, are well known in the art.

The placemat 13, 23, 33, 43, 53, 63, 73, 83, 93, 103, could made from a material selected from a group comprising, fabric, plastic, vinyl, washable material, to name a few.

Similarly, the material for the layers 14, 16, 24, 26, and 34, could be selected from a group comprising, fabric, plastic, vinyl, washable material, to name a few.

The securing device 38, 71, 78, could be selected from a group comprising, magnets, rivets, hooks, hook and loop device, such as, a VELCRO device, buttons, snaps, zippers, slots, grooves, male/female engaging members, to name a few.

The securing devices 76, 77, could be selected from a group comprising, magnets, rivets, hooks, hook and loop device, such as, a VELCRO device, buttons, snaps, zippers, slots, grooves, male/female engaging members, latches, to name a few.

It should be appreciated that the shape 10, 20, 30, 40, 50, 60, 70, of the placemat 13, 23, 33, 43, 53, 63, 73, 83, 93, 103, could be selected from a group comprising of a rectangular shape, a triangular shape, a circular shape, an elliptical shape, a polygonal shape, an ornamental-type shape, a heart-type shape, an irregular shape, just to name a few.

It should also be appreciated that the placemat 13, 23, 33, 43, 53, 63, 73, 83, 93, 103, could have at least one inscription 12, 22, 32, 42, 52, 62, and wherein the inscription could be selected from a group comprising of a design, an indicia, a drawing, a photograph, a scenery, a picture, an illustration, a gesture, a smiley-type face, a phrase, a statement, a rhyme, an alphabet, a numeral, a symbol, a visual message, a graphic image, a verbiage, just to name a few.

The placemat 13, 23, 33, 43, 53, 63, 73, 83, 93, 103, can preferably have a second layer which can comprise a securing means 38, 71, and wherein the securing means 38, 71, could be selected from a group comprising a magnetic material, a non-skid-type plastic material, hooks, a hook and loop device, a snap, a suction-type cup, a male engaging member, a female engaging member, to name a few.

The material for the placemat 13, 23, 33, 43, 53, 63, 73, 83, 93, 103, could be selected from a group comprising a fabric material, a plastic material, a vinyl material, a metallic composite type material, a washable-type material, to name a few.

The inventive lunch box 75, could have at least one means to internally securely hold at least one placemat, and wherein the at least one securing means could be selected from a group comprising a magnetic material, a non-skid-type plastic material, hooks, a hook and loop device, a snap, a suction-type cup, a male engaging member, a female engaging member, to name a few.

The “Lunch Pad” could be, for example, approximately 12 inches in diameter and would be able to roll or fold up to fit inside a lunch box. However, it should be understood that the “Lunch Pad” or “Lunch Spot” or placemat 13, 23, 33, 43, 53, 63, 73, 83, 93, 103, can be of any size or dimension depending on the application or the desire of a consumer.

The lunch box 75, preferably has a cover or lid 72, and wherein the cover 72, has at least one securing means 76, to secure the cover 72, to at least a portion of one of the four walls of the container 74, having at least one securing means 77, and wherein the at least one securing means 76, 77, are selected from a group comprising, a magnet, a hook and loop-type device, a snap-type device, a male engaging member, a female engaging member, a latch, to name a few.

The lunch box 75, preferably has at least one means to internally, removably, securely hold at least one placemat 13, 23, 33, 43, 53, 63, 73, 83, 93, 103, and wherein the at least one securing means 71, is selected from a group comprising, a magnetic material, a non-skid-type plastic material, hooks, a hook and loop device, a snap, a suction-type cup, a male engaging member, a female engaging member, just to name a few.

It is anticipated that the primary users of the placemat 13, 23, 33, 43, 53, 63, 73, 83, 93, 103, would be children in a school cafeteria setting. However, the placemat 13, 23, 33, 43, 53, 63, 73, 83, 93, 103, could be used in other places, such as, to provide an additional advantage of saving paper, i.e., napkins, paper-towels, to name a few, while providing a sanitary space.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A washable placemat, comprising:
(a) a first layer, a second layer secured to said first layer; and
(b) wherein said first layer and said second layer are made from a recycled, recyclable material, and thereby forming said washable placement.

2. The washable placemat of claim 1, wherein the shape said first layer is selected from a group consisting of rectangular shape, a triangular shape, a circular shape, an elliptical shape, a polygonal shape, an ornamental-type shape, a heart-type shape, and an irregular shape.

3. The washable placemat of claim 1, wherein the shape said second layer is selected from a group consisting of rectangular shape, a triangular shape, a circular shape, an elliptical shape, a polygonal shape, an ornamental-type shape, a heart-type shape, and an irregular shape.

4. The washable placemat of claim 1, wherein said first layer facing a user has an inscription, wherein said inscription is selected from a group consisting of a design, an indicia, a drawing, a photograph, a scenery, a picture, an illustration, a gesture, a smiley-type face, a phrase, a statement, a rhyme, an alphabet, a numeral, a symbol, a graphic image, a verbiage, and a visual message.

5. The washable placemat of claim 1, wherein said second layer facing a user has an inscription, wherein said inscription is selected from a group consisting of a design, an indicia, a drawing, a photograph, a scenery, a picture, an illustration, a gesture, a smiley-type face, a phrase, a statement, a rhyme, an alphabet, a numeral, a symbol, a graphic image, a verbiage, and a visual message.

6. The washable placemat of claim 1, wherein at least one magnetic material is securely held in place between said first layer and said second layer.

7. The washable placemat of claim 1, wherein at least one magnetic layer is securely held in place between said first layer and said second layer.

8. The washable placemat of claim 1, wherein at least one discrete magnet is securely held in place between said first layer and said second layer.

9. The washable placemat of claim 1, wherein said second layer comprises a securing means.

10. The washable placemat of claim 1, wherein said second layer comprises a securing means, and wherein said securing means is selected from a group consisting of a magnetic material, a non-skid-type plastic material, hooks, a hook and loop device, a snap, a suction-type cup, a male engaging member, and a female engaging member.

11. The washable placemat of claim 1, wherein material for said placemat is selected from a group consisting of a fabric material, a plastic material, a vinyl material, a metallic composite type material, and a washable-type material.

12. A lunch box, comprising:
(a) a container formed by four walls with a base secured to the bottom edges of said four walls;
(b) a cover hingeably secured to an upper edge of a wall; and
(c) said lunch box having at least one means to internally securely hold at least one placemat.

13. The lunch box of claim 12, wherein at least one wall has at least one securing means to internally secure said at least one placemat.

14. The lunch box of claim 12, wherein said cover has at least one securing means to internally secure said at least one placemat.

15. The lunch box of claim 12, wherein said cover has at least one securing means to secure said cover to at least a portion of one of said four walls.

16. The lunch box of claim 12, wherein said cover has at least one first securing means to secure said cover to at least a portion of one of said four walls having at least one second securing means, and wherein said at least one first and second securing means are selected from a group consisting of a magnet, a hook and loop-type device, a snap-type device, a male/female engaging member, and a latch.

17. The lunch box of claim 12, wherein said lunch box has at least one means to internally securely hold said at least one placemat, and wherein said at least one securing means is selected from a group consisting of a magnetic material, a non-skid-type plastic material, hooks, a hook and loop device, a snap, a suction-type cup, a male engaging member, and a female engaging member.

18. A combination placemat and lunch box, comprising:
(a) a container formed by four walls with a base secured to the bottom edges of said four walls;
(b) a cover hingeably secured to an upper edge of a wall, and forming said lunch box;
(c) said lunch box further having at least one first means to internally, removably, and securely hold at least one placemat; and
(d) a placemat having at least one second means to be removably, and securely, be held by said at least one first means in said lunch box that internally, removably, and securely holds said at least one placemat.

19. The combination placemat and lunch box of claim 18, wherein material for said placemat is selected from a group consisting of a fabric material, a plastic material, a vinyl material, a metallic composite type material, and a washable-type material, and wherein said at least one second securing means is selected from a group consisting of a magnetic material, a non-skid-type plastic material, hooks, a hook and loop device, a snap, a suction-type cup, a male engaging member, and a female engaging member.

20. The combination placemat and lunch box of claim 18, wherein said at least one first securing means is selected from a group consisting of a magnetic material, a non-skid-type plastic material, hooks, a hook and loop device, a snap, a suction-type cup, a male engaging member, and a female engaging member, and wherein said at least one second securing means is selected from a group consisting of a magnetic material, a non-skid-type plastic material, hooks, a hook and loop device, a snap, a suction-type cup, a male engaging member, and a female engaging member.
